(19) United States
(12) Patent Application Publication
(10) Pub. No.: US 2018/0091710 A1
(43) Pub. Date: Mar. 29, 2018

(54) IMAGE PROCESSING SYSTEM AND FLASHLIGHT DEVICE

(71) Applicant: Acer Incorporated, New Taipei City (TW)

(72) Inventors: Yen-Ching HUANG, New Taipei City (TW); Jian-Wei LEE, New Taipei City (TW)

(21) Appl. No.: 15/362,729

(22) Filed: Nov. 28, 2016

(30) Foreign Application Priority Data
Sep. 29, 2016 (TW) 105131237

(51) Int. Cl. H04N 5/225; H04N 5/235; G02B 7/02

(52) U.S. Cl. CPC H04N 5/2256; H04N 5/2354; H04N 9/045; G02B 7/021; G02B 7/023; H04N 5/2351

(57) ABSTRACT

The present invention provides a flashlight device, including a base, a plurality of rotation mechanisms, a plurality of lens modules, at least one light source, and a control circuit. The rotation mechanisms are disposed on the base. The lens modules are installed on the respective rotation mechanisms. The light source is configured to emit light beams to the plurality of lens modules. The control circuit is configured to receive a command signal to generate a first control signal and a second control signal. The control circuit sends the first control signal to at least one rotation mechanism so as to control the rotation mechanism to drive the corresponding lens module. The control circuit sends the second control signal to the light source so as to control the brightness of the light beams emitted from the light source.

### CROSS REFERENCE TO RELATED APPLICATIONS

This Application claims priority of Taiwan Patent Application No. 105131237, filed on Sep. 29, 2016, the entirety of which is incorporated by reference herein.

### BACKGROUND OF THE INVENTION

### Field of the Invention

The present invention relates to a flashlight device, and in particular to a flashlight device capable of adjusting brightness and lighting angles.

### Description of the Related Art

Electronic devices (such as tablet PCs, smartphones, or notebooks) are widely-applied in a variety of fields, while a camera module and a flashlight module are disposed on reverse side of the electronic devices for the electronic devices. Users can execute applications on their electronic devices to control the camera module and the flashlight module to take a photograph. However, the output brightness of the flashlight module disposed on many electronic devices is insufficient to deal with darker scenes, and as a result the photographs captured by the user in low-light conditions are unclear, due to insufficient brightness.

The general solution to this problem is adding a high-power flashlight device to emit a brighter light beam in dark conditions. As a result, the problem of having insufficient brightness to take photographs of darker scenes is solved. However, no matter whether the flashlight module is disposed on the electronic device, or via an added flashlight module, the emitting direction of the light beams of the flashlight module is the same as the capture direction of the lens, and it is fixed. Consequently, the captured photograph still has the problem of uneven brightness. For example, part of the captured image may be noticeably darker or brighter than the rest of the image.

In view of this, it is worth discussing development of a flashlight device for solving the problem of insufficient brightness or uneven brightness of captured images.

### BRIEF SUMMARY OF THE INVENTION

For the reasons listed above, the present invention provides a flashlight device, so as to solve the aforementioned problems.

The present invention provides a flashlight device, including a base, a plurality of rotation mechanisms, a plurality of lens modules, at least one light source, and a control circuit. The rotation mechanisms are disposed on the base. The lens modules are installed on the respective rotation mechanisms. The light source is configured to emit light beams to the plurality of lens modules. The control circuit is configured to receive a command signal to generate a first control signal and a second control signal. The control circuit sends the first control signal to at least one rotation mechanism so as to control the rotation mechanism to drive the corresponding lens module. The control circuit sends the second control signal to the light source so as to control the brightness of the light beams emitted from the light source. The invention further discloses an image processing system.

The present invention provides an image processing system, comprising: an electronic device and a flashlight device. The electronic device comprises a camera module and a processing circuit. The processing circuit performs an image analyzing procedure on a preview image or an image captured from the camera module and generates a command signal accordingly. The flashlight device comprises a base, a plurality of rotation mechanisms, a plurality of lens modules, at least one light source and a control circuit. The rotation mechanisms are disposed on the base. The lens modules are installed on the respective rotation mechanisms. The light source is configured to emit light beams to the plurality of lens modules. The control circuit is configured to receive a command signal to generate a first control signal and a second control signal. The control circuit sends the first control signal to at least one rotation mechanism so as to control the rotation mechanism to drive the corresponding lens module. The control circuit sends the second control signal to the light source so as to control the brightness of the light beams emitted from the light source. The invention further discloses an image processing system.

The present invention provides a flashlight device with a detachable design installed on the rear surface of an electronic device. In one embodiment of the present invention, when the user is taking a photograph using the electronic device, the electronic device captures a first image and then performs an analysis on the first image automatically, so as to determine whether the first image has a darker part and whether there is color difference. In another embodiment of the present invention, the electronic device uses a preview image to obtain an image, performs the analysis on the preview image, adjusts the parameters of the preview image, and takes the photograph after the parameters of the preview image are adjusted. If the first image has a darker part, the processing circuit sends the command signal to the control circuit, the control circuit controls some of rotation mechanisms or all mechanism rotate towards the darker side of the scene according to the command signal, and the processing circuit controls the flashlight device to emit another light beam and controls the camera module to take a photograph to obtain a modified second image. If there is color difference, the processor circuit sends the command signal to the control circuit, and the control circuit controls the light source according to the command signal, so as to emit the light beam equipped with color temperature to compensate for the lighting problems in the scene. Consequently, un-equal brightness problem in the captured image, which is caused by the emitted directions of the flashlight device of the electronic device and the lens are same, fixed and un-tuned, is solved. In addition, the present invention compensates for color temperature.

### BRIEF DESCRIPTION OF THE DRAWINGS

FIG. 1 is a block diagram of an imaging process system of an embodiment of the present invention;

FIG. 2 is a schematic diagram of an imaging process system of an embodiment of the present invention;

FIG. 3 is a profile schematic diagram of a rotation mechanism and a lens module of an embodiment of the present invention;

FIG. 4 is a 3D schematic diagram of a rotation mechanism and a lens module of an embodiment of the present invention;

FIG. 5 is another schematic diagram of an imaging process system of an embodiment of the present invention;

FIG. 6 is another schematic diagram of a flashlight device of an embodiment of the present invention;

FIG. 7 is another schematic diagram of a rotation mechanism and a lens module of an embodiment of the present invention; and

FIG. 8 is another 3D schematic diagram of a rotation mechanism and a lens module of an embodiment of the present invention.

### DETAILED DESCRIPTION OF THE INVENTION

Various embodiments of the present invention are described in detail with reference to the accompanying drawings. The same reference numbers used in the drawings refer to the same or similar elements. The purpose of these embodiments is to illustrate the general principles of the present invention and the invention is not limited thereto.

It should be noted that “an embodiment” or “one embodiment” of the present invention does not necessarily refer to the same embodiment, “an embodiment” or “one embodiment” of the present invention refers to “at least one embodiment.” Furthermore, when a combination of a particular feature, structure, or characteristic is described in one embodiment of the present invention, it should be noted that a person skilled in the art can connect the particular feature, structure, or characteristic to remaining embodiments of the present invention within the scope of the art, no matter whether the detailed descriptions exist.

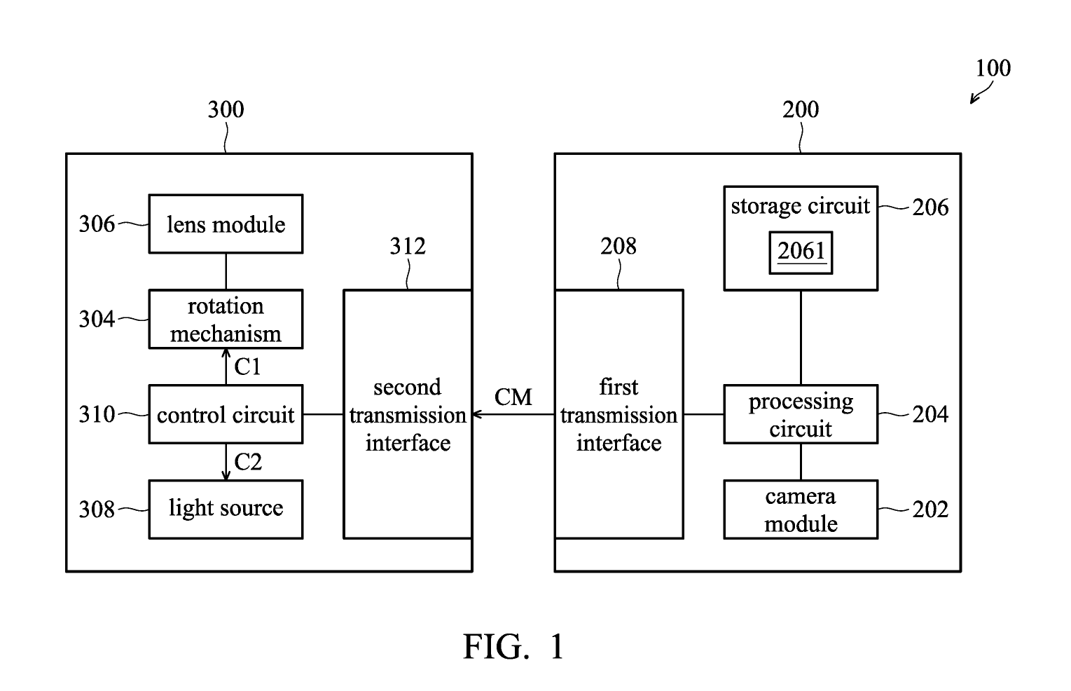

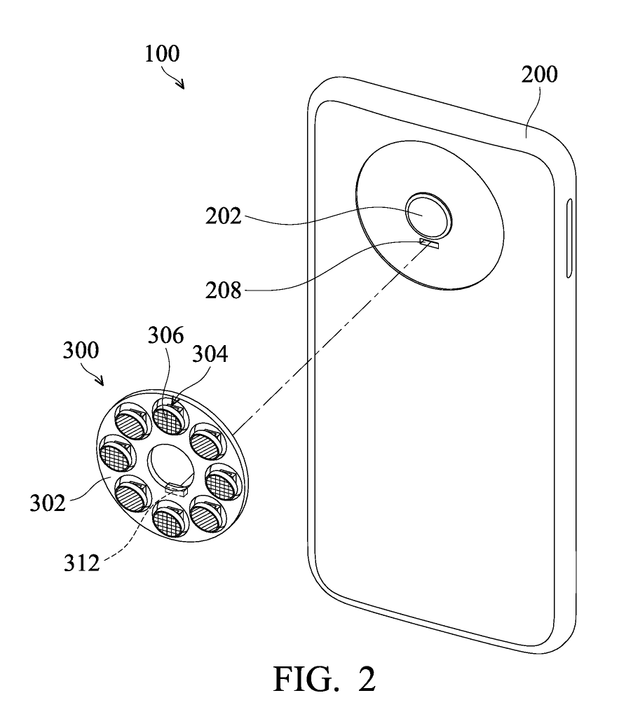

Please refer to FIG. 1 and FIG. 2, FIG. 1 is a block diagram of an imaging process system 100 of an embodiment of the present invention, and FIG. 2 is a schematic diagram of the imaging process system 100 of an embodiment of the present invention. The imaging process system 100 comprises an electronic device 200 and a flashlight device 300. The electronic device 200 comprises a camera module 202, a processing circuit 204, a storage circuit 206, and a first transmission interface 208. The camera module 202 is a photosensitive element (such as a CCD or a CMOS photosensitive module), and the processing circuit 204 controls the camera module 202 to generate an image for external environments of the electronic device 200. The processing circuit 204 receives the image, performs an image analysis procedure on the image to generate a command signal CM, and outputs the command signal CM via the first transmission module 208.

The processing circuit 204 has the functions of a central processing unit (CPU) and a graphics processing unit (GPU). The CPU is configured to control the operations of the electronic device 200. The CPU is required to have processing abilities to execute functions of an operation system (OS), a program, user graphical interface, software, a module, an application, and the electronic device 200. The CPU comprises a single processor or a plurality of processors. For example, the CPU is a combination of general microprocessors and the specific-purpose processors and/or an interrelated chipset. The combination of general microprocessors and the specific-purpose processors is an instruction-set processor, a graphic processor, a video processor, an audio processor, and a specific-purpose microprocessor.

The storage circuit 206 is a random access memory (RAM), a flash memory, a Read-Only Memory (ROM), an Erasable Programmable Read Only Memory (EPROM), an Electrically-Erasable Programmable Read-Only Memory (EEPROM), a register, a hard drive, a portable hard drive, a Compact Disc Read-Only Memory (CD-ROM) or another medium capable of being read by other computers in the art. A photograph application 2061 is stored in the storage circuit 206, the processing circuit 204 executes the photograph application 2061 to control the camera module 202 to take photographs, and the processing circuit 204 stores the images (or photographs) captured by the camera module 202 into the storage circuit 206.

The electronic device 200 is a portable device or a handheld device, such as a personal digital assistant (PDA), a smartphone, a tablet, a mobile phone, a mobile internet device (MID), a notebook computer, a digital camera, a digital media player, a gaming device, or any other type of mobile computing device. However, it will be understood by a person skilled in the art that the present invention is not limited thereto.

The flashlight device 300 is designed as an integrally-formed device in a rear surface of the electronic device 200 or a detachable device set in a rear surface of the electronic device 200 (as shown in FIG. 2). The flashlight device 300 comprises a base 302, a plurality of rotation mechanisms 304, a plurality of lens modules 306, at least one light source 308, a control circuit 310, and a second transmission interface 312. The base 302 is detachable. For example, the base 302 is engaged with a circular groove/recess of the rear surface of the electronic device 200 via an engaged structure. The lens modules 306 are installed on the respective rotation mechanisms 304, and the rotation mechanisms 304 are disposed in a plurality of grooves/recesses of the base 302. In one embodiment of the present invention, the rotation mechanisms 304 are disposed on the base 302 in a symmetrical manner, but the present invention is not limited thereto. In another embodiment of the present invention, the rotation mechanisms 304 are disposed on the base 302 in a regular manner. For example, the rotation mechanisms 304 are disposed on the base 302 at a ratio of 6:4.

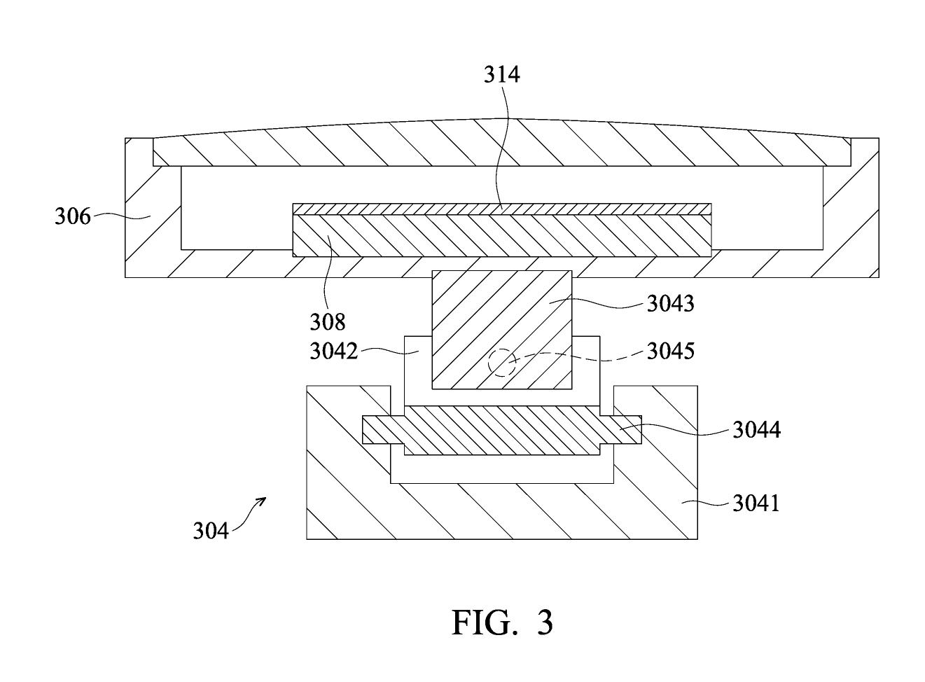

Please refer to FIG. 1, FIG. 2, and FIG. 3. FIG. 3 is a profile schematic diagram of a rotation mechanism 304 and a lens module 306 of an embodiment of the present invention. As shown in FIG. 3, the lens module 306 comprises a light source 308. Namely, the flashlight device 300 comprises a plurality of light sources 308 in this embodiment of the present invention, and the light sources 308 are respectively disposed in the lens modules 306. Each light source 308 is a light-emitting diode (LED) and is configured to emit light beams through each of the lens modules 306.

The control circuit 310 receives a command signal CM from the first transmission interface 208 of the electronic device 200 to generate a first control signal C1 and a second control signal C2 via a second transmission interface 312. The control circuit 310 sends the first control signal C1 to at least one rotation mechanism 304, so as to control the rotation mechanism 304 to rotate the corresponding lens module 306. The control circuit 310 sends the second control signal C2 to the plurality of light sources 308, so as to control the light beams emitted from the plurality of light sources 308 through the plurality of lens modules 306 and to control the brightness of the light beams.

In addition, in this embodiment of the present invention, the plurality of light sources 308 are divided into a first set of light sources and a second set of light sources. The first set of light sources and the second set of light sources have different color temperatures, and the first set of light sources and the second set of light sources are respectively disposed in the plurality of lens modules 306 in such a way that they are spaced apart from each other. As shown in FIG. 2, the flashlight device 300 comprises eight lens modules 306. The lens modules 306 with a slash line are represented as the first set of light sources and the color temperature of the first set of light sources is 5500K, while the lens modules 306 with crossed lines is represented as the second set of light sources and the color temperature of the second set of light sources is 2500K. The second control signal C2 emitted from the control circuit 310 adjusts a first driving current and a second driving current. Namely, the first set of light sources and the second set of light sources respectively output light beams with different brightness according to the second control signal C2 so that light beams emitted from the first set of light sources and the second set of light sources are mixed as an output light beam with a specific color temperature.

As shown in FIG. 3, each lens module 306 comprises an LCD assembly 314, the control circuit 310 generates a corresponding control voltage, and the control circuit 310 selectively sends the corresponding control voltage to the LCD assembly 314 of the lens modules 306 required to be controlled, so as to control the liquid-crystal molecules in the LCD assembly 314 twisted. Consequently, the control circuit 310 adjusts the brightness of the light beams emitted from the lens module 306 via a grip of the LCD assembly 314.

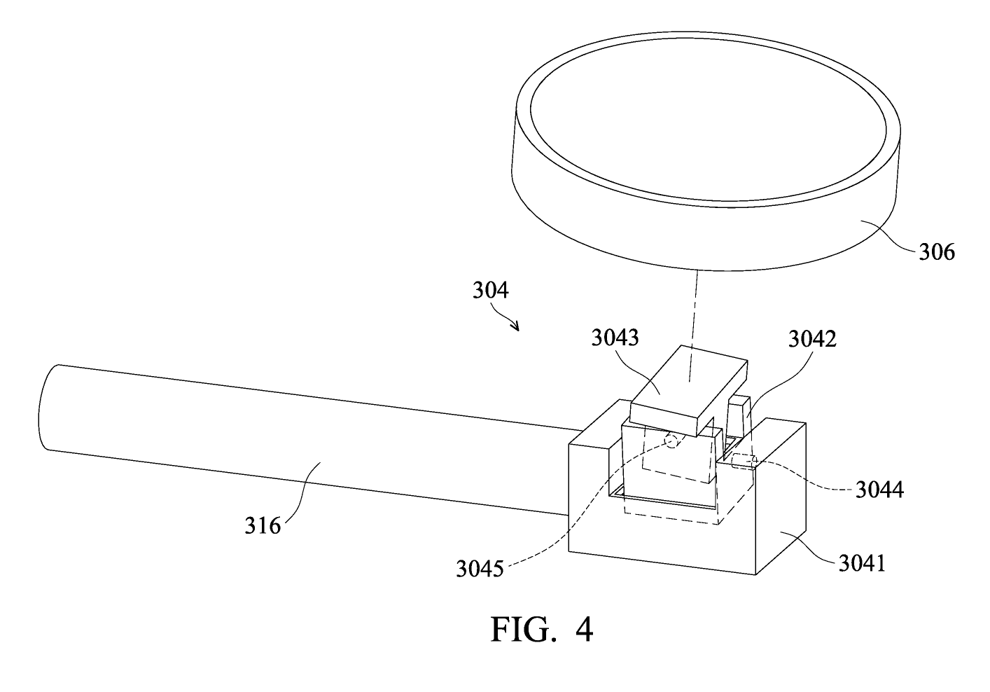

Please refer to FIG. 3 and FIG. 4. FIG. 4 is a 3D schematic diagram of a rotation mechanism 304 and a lens module 306 of an embodiment of the present invention. The rotation mechanism 304 operates according to the first control signal C1, and the rotation mechanism 304 comprises a first base 3041, a second base 3042, a third base 3043, a first rotating shaft 3044, and a second rotating shaft 3045. The first base 3041 is fixedly disposed on a circular groove/recess of the base 302. The second base 3042 is pivotally connected to the first base 3041 via the first rotating shaft 3044 so that the second base 3042 regards the first rotating shaft 3044 as a rotating shaft to rotate with respect to the first base 3041. The third base 3043 is pivotally connected to the second base 3042 via the second rotating shaft 3045 so that the third base 3043 regards the second rotating shaft 3045 as a rotating shaft to rotate with respect to the second base 3042. The lens module 306 is disposed on the third base 3043. The first rotating shaft 3044 and the second rotating shaft 3045 are driven by a step motor or a linear motor, but the present invention is not limited thereto. Consequently, the rotation mechanism 304 rotates according to the first control signal C1, so as to rotate the corresponding lens module 306.

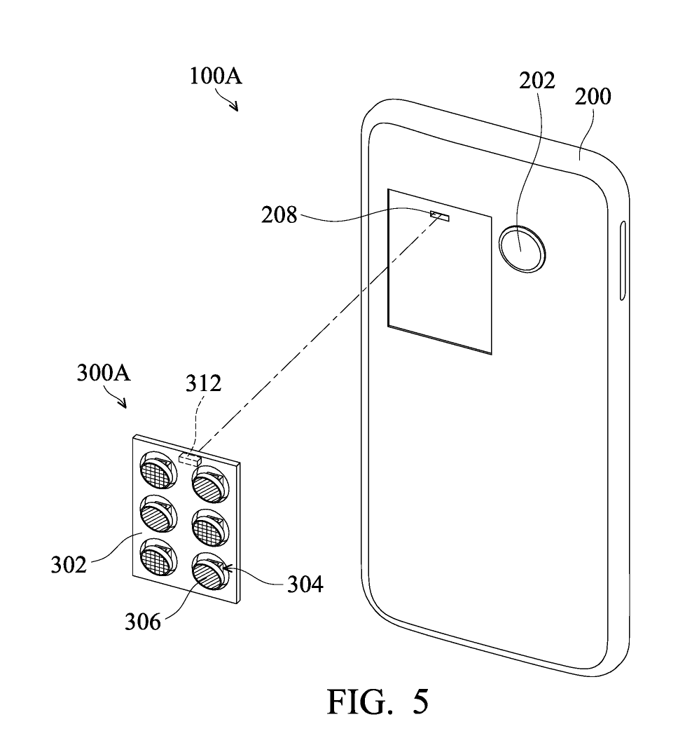

Please refer to FIG. 5, which is another schematic diagram of an imaging process system 100A of an embodiment of the present invention. The differences from the imaging process system 100 are the base 302 of the flashlight device 300A in this embodiment of the present invention is a rectangle and the base 302 of the flashlight device 300A in this embodiment of the present invention is disposed near the camera module 202. Similarly, the rotation mechanisms 304 and the lens modules 306 of the flashlight device 300A are disposed on the base 302. In one embodiment of the present invention, the rotation mechanisms 304 are disposed symmetrically on the base 302 and the lens modules 306 are disposed symmetrically on the base 302, but the present invention is not limited thereto. In another embodiment of the present invention, the rotation mechanisms 304 and the lens modules 306 are disposed on the base 302 in a regular manner. For example, the rotation mechanisms 304 and the lens modules 306 are disposed on the base 302 at a ratio of 6:4.

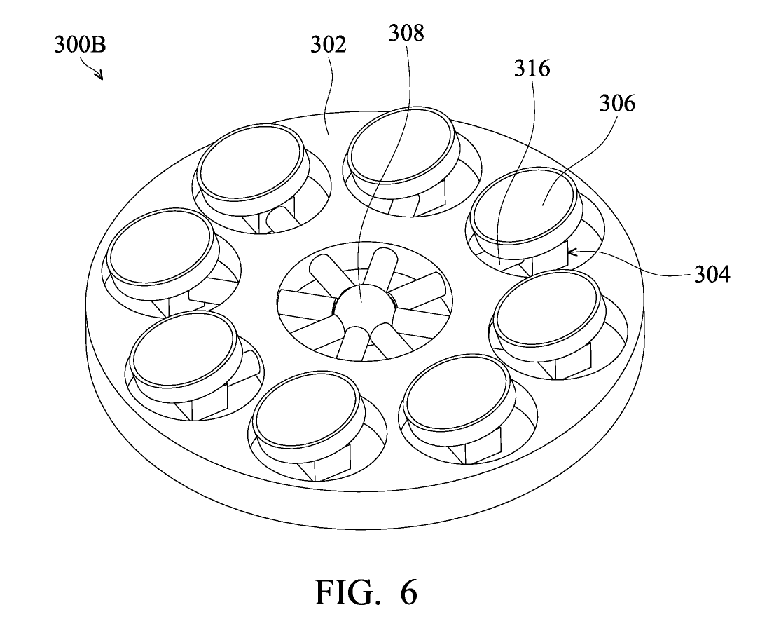

Please refer to FIG. 6, which is another schematic diagram of a flashlight device 300B of an embodiment of the present invention. In this embodiment of the present invention, the flashlight device 300B is disposed near the camera module 202 of the electronic device 200, and the flashlight device 300B only comprises a light source 308 disposed at the center of the base 302. In addition, the flashlight device 300B further comprises a plurality of light-guiding structures 316 to connect with the light source 308 and the plurality of rotation mechanisms 304. The plurality of light-guiding structures 316 is hollow and opaque, and the each of the light-guiding structures 316 is a tubular body. The light beams emitted from the light source 308 are directed to the lens modules 306 via the plurality of light-guiding structures 316 and the plurality of rotation mechanisms 304. In one embodiment of the present invention, the rotation mechanisms 304 are utilized to design a specific rotation angle to completely block light from the plurality of light-guiding structures 316. In another embodiment of the present invention, the rotation mechanisms 304 are utilized to design another circuit to turn off light for the specific lens.

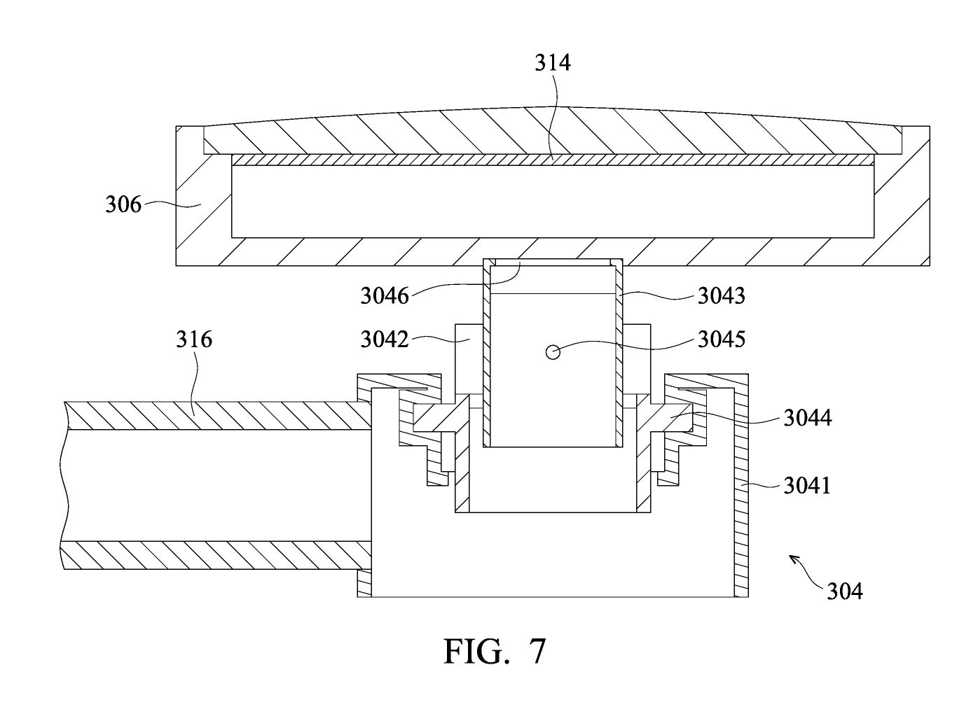

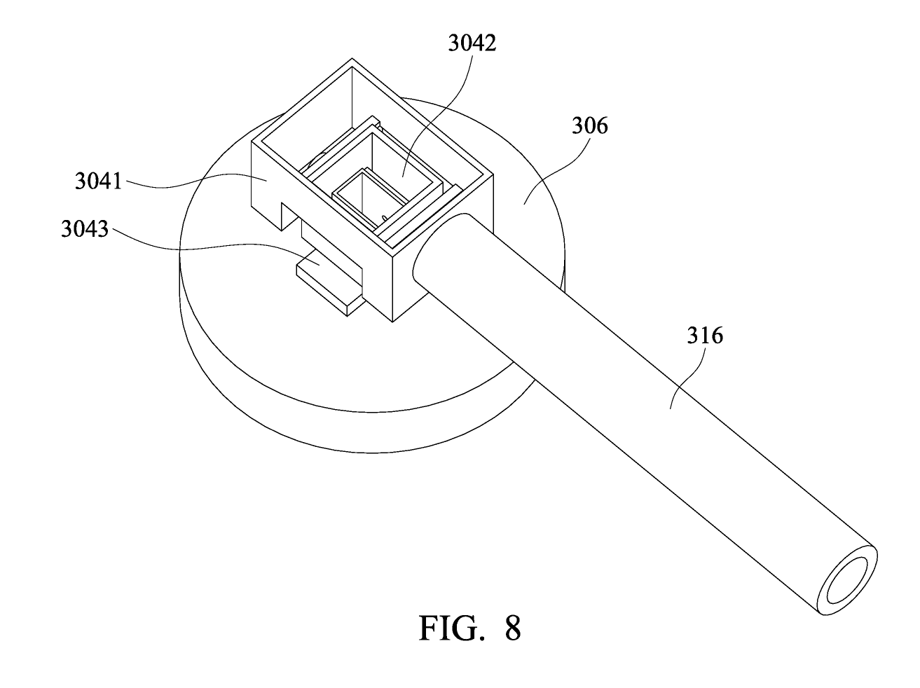

Please refer to FIG. 7 and FIG. 8. FIG. 7 is another schematic diagram of a rotation mechanism 304 and a lens module 306 of an embodiment of the present invention, and FIG. 8 is another 3D schematic diagram of a rotation mechanism 304 and a lens module 306 of an embodiment of the present invention. The first base 3041, the second base 3042, and the third base 3043 are made of translucent material, and inner wall surfaces of the second base 3042 and the third base 3043 are coated with materials for reflecting light. The light-guiding structures 316 are connected to any position of the first base 3041 and direct the light beam of the light source 308 to the first base 3041. From FIG. 7 and FIG. 8, the second base 3042 and the third base 3043 do not have bottom parts, a lower part of the third base 3043 is disposed on the inner part of the second base 3042, and the lower part of the second base 3042 is disposed on the inner part of the first base 3041. Consequently, the light beam is reflected via the inner wall surfaces of the first base 3041 through the second base 3042 and the third base 3043, and the light beam is finally emitted out of an opening 3046 of the third base 3043 to enter the lens module 306. Similarly, the LCD assembly 314 can be disposed in the lens module 306, so as to adjust the brightness of the light beam emitted from the lens module 306.

Furthermore, the light source 308 is an LED module and comprises a plurality of LEDs with different color temperatures (for example, two LEDs with 5500K and 2500K) in this embodiment of the present invention, and thus, the LED module emits light beams with different color temperatures according to the second control signal C2.

In another embodiment of the present invention, the light source 308 is an LED equipped with a single color temperature (for example, white light), while every lens module 306 comprises a color filter, so as to filter light beams emitted from the light source 308 as a light beam with a specific color temperature. The color filters disposed in each lens module 306 are the same or different, and the color filters disposed in each lens module 306 are determined according to design requirements.

As indicated by the operating flowchart of the imaging processing system 100, first, a user activates a photograph application 2061 of the electronic device 200 with the flashlight device 300 (for example, a smartphone). In one embodiment of the present invention, when a shutter release button is pressed by the user, the processing circuit 204 sends the command signal CM so that the flashlight device 300 emits light beams and controls the camera module 202 to take a photograph to obtain a first image, and then the processing circuit 204 performs an image analyzing procedure on the first image. For example, when the right side of the first image is darker, it means that the right side of light source is weaker in a photo-shooting scene. Consequently, the processing circuit 204 sends the command signal CM to the control circuit 310, the control circuit 310 sends the first control signal C1 to control part of the rotation mechanism 304, or the whole rotation mechanism 304, to rotate towards the right side of the shooting scene according to the command signal CM, and then, the processing circuit 204 controls the flashlight device 300 to emit the light beam again and controls the camera module 202 to take a photograph to obtain a modified second image. Compared to the first image, the right side of the modified second image obtains more light so as to improve the lighting of the image. In this embodiment of the present invention, the electronic device captures the first image first and automatically performs the analysis on the first image, but the present invention is not limited thereto. In another embodiment, the electronic device utilizes a preview image to capture the image and automatically performs an analysis and parameter adjustment on the preview image, and the photograph is taken after the parameter adjustment is done.

In addition, the processing circuit 204 analyzes the color of the first image. If the color of the first image belongs to a cold color, the processing circuit 204 sends the command signal CM to the control circuit 310, the control circuit 310 sends the second control signal C2 to the light source 308 according to the command signal CM so as to control the light beam of a warm color jointly emitted from the first set of light beams and the second set of light beams, and controls the camera module 202 to take a photograph to obtain a modified third image.

Compared to the prior art, the present invention provides a flashlight device with a detachable design installed on the rear surface of the electronic device 200. In one embodiment of the present invention, when the user is taking a photograph using the electronic device 200, the electronic device 200 captures a first image first and performs an analysis on the first image automatically, so as to determine whether the first image has a darker part and whether there is color difference. If the first image has a darker part, the processing circuit 204 sends the command signal CM to the control circuit 310, the control circuit 310 controls a part of the rotation mechanism 304, or the whole rotation mechanism 304, to rotate towards the darker side of the shooting scene according to the command signal CM, and the processing circuit 204 controls the flashlight device 300 to emit the light beam again and controls the camera module 202 to take a photograph to obtain a modified second image. If there is color difference, the processor circuit 204 sends the command signal CM to the control circuit 310, and the control circuit 310 controls the light source 308 according to the command signal CM, so as to emit the light beam equipped with color temperature for compensate the photo-shooting scene. In another embodiment of the present invention, if there are spot lights in part of human face because the light strength of the light source is too high, the distance between the light source and the human face is too close, and the background is too dark, the processing circuit 204 sends the command signal CM to the control circuit 310, the control circuit 310 controls a part of the rotation mechanism 304, or the whole rotation mechanism 304, to rotate away from the spot light area of the shooting scene according to the command signal CM, and the processing circuit 204 controls the flashlight device 300 to emit the light beam again and controls the camera module 202 to take a photograph to obtain a modified second image. Consequently, un-equal brightness problem in the captured image, which is caused by the emitted directions of the flashlight device of the electronic device and the lens are same, fixed and un-tuned, is solved. In addition, the present invention compensates for color temperature. In this embodiment of the present invention, the electronic device captures the first image first and performs the analysis on the first image automatically, but the present invention is not limited thereto. In another embodiment of the present invention, the electronic device may utilize a preview image to obtain an image, perform an analysis on the preview image, adjust the parameters of the preview image, and take the photograph after the parameters of the preview image have been adjusted.

The method of the present invention, or certain aspects or portions thereof, may exist in the form of program code. The program code can be stored in physical media, such as floppy discs, hard disk, or any other machine-readable (computer-readable) storage media, or one that is not limited to the external form of a computer program product. When the program code is executed (for example, loaded by a computer), this machine is becoming involved in the device of the present invention. The program code can also be transmitted through some transmission media, such as a wire or cable, fiber optics, or any transmission patterns used for transmission. When the program code is received, loaded and executed by a machine (such as a computer), this machine becomes an apparatus for practicing the invention. When a general-purpose processor is implemented, the program code combines with the processor to provide a unique apparatus that operates similar to application-specific logic circuits.

It should be understood that the elements recited in the appended claims may be combined with features in different ways to generate new claims and are equally within the scope of the present invention. Accordingly, in view of the following claims depend on a single independent claim or a dependent claim, it should be understood that these dependent claims selectively depend on any of the preceding or following claims, and such new combinations of the dependent claims and any of the preceding or following claims is understood as forming a part of the specification of the present invention.

The present invention is described by examples and preferred embodiments, but it should be understood that the present invention is not limited thereto. It will be apparent to those skilled in the art that various changes and modifications can be made therein without departing from the scope and spirit of the present invention. Accordingly, the scope of the invention may be defined and protected by the following claims and their equivalents.

1. A flashlight device, comprising:
a base;
a plurality of rotation mechanisms, disposed on the base;
a plurality of lens modules, installed on the respective rotation mechanisms;
at least one light source, configured to emit light beams to the plurality of lens modules to make the light beams be emitted through the lens modules; and
a control circuit, configured to receive a command signal to generate a first control signal and a second control signal, wherein the control circuit sends the first control signal to at least one of the rotation mechanisms so as to control the rotation mechanism to drive the corresponding lens module, and the control circuit sends the second control signal to the light source so as to control brightness of the light beams emitted from the light source.

2. The flashlight device as claimed in claim 1, wherein the flashlight device comprises a plurality of light sources, the light sources are respectively disposed in the plurality of lens modules, and the light sources emit light beams through the lens modules according to the second control signal.

3. The flashlight device as claimed in claim 2, wherein each of the light sources is an LED, the light sources are divided into a first set of light sources and a second set of light sources, the first set of light sources and the second set of light sources have different color temperatures, and the first set of light sources and the second set of light sources respectively are disposed spaced apart from each other in the plurality of lens modules.

4. The flashlight device as claimed in claim 3, wherein the first set of light sources and the second set of light sources respectively output light beams with different brightness according to the second control signal so that light beams emitted from the first set of light sources and the second set of light sources are mixed as an output light beam with a specific color temperature.

5. The flashlight device as claimed in claim 1, wherein each of the lens modules comprises at least one LCD assembly, the control circuit generates a corresponding control voltage, and the control circuit selectively sends the corresponding control voltage to the at least one of the lens modules to control the LCD assembly of the at least one of the lens module so that the LCD assembly adjusts brightness of the light beams emitted from the at least one of the lens modules.

6. The flashlight device as claimed in claim 1, wherein the light source is disposed on the center of the base, the flashlight device further comprises a plurality of light-guiding structures to connect with the light source and the rotation mechanisms, and a light beam emitted from the light source is directed to the lens modules via the plurality of light-guiding structures and the plurality of rotation mechanisms.

7. The flashlight device as claimed in claim 6, wherein the light source is an LED module, the LED module comprises LEDs with different color temperatures, and the LED module emits light beams with different color temperatures according to the second control signal.

8. The flashlight device as claimed in claim 6, wherein each of the lens modules has a color filter so as to emit a light beam with specific color temperature.

9. The flashlight device as claimed in claim 6, further comprising a transmission interface to connect with an external electronic device, and the control circuit receives the command signal from the external electronic device via the transmission interface.

10. An image processing system, comprising:
an electronic device, comprising:
a camera module;
a processing circuit, performing an image analyzing procedure on a preview image or an image captured from the camera module and generating a command signal accordingly; and
a flashlight device, comprising:
a base;
a plurality of rotation mechanisms, disposed on the base;
a plurality of lens modules, installed on the respective rotation mechanisms;
at least one light source, configured to emit light beams to the plurality of lens modules to make the light beams be emitted through the lens modules; and
a control circuit, configured to receive the command signal to generate a first control signal and a second control signal, wherein the control circuit sends the first control signal to at least one of the rotation mechanisms so as to control the rotation mechanism to drive the corresponding lens module, and the control circuit sends the second control signal to the light source so as to control the brightness of the light beams emitted from the light source.
